(19) United States
(12) Patent Application Publication
(10) Pub. No.: US 2005/0021415 A1
(43) Pub. Date: Jan. 27, 2005

(54) Systems, methods and computer program products for online ordering of business directory listings and advertisements

(76) Inventor: Wealthy Desai, Atlanta, GA (US)

Correspondence Address: MYERS BIGEL SIBLEY & SAJOVEC, P.A., P.O. BOX 37428, RALEIGH, NC, 27627, US

(21) Appl. No.: 10/624,325

(22) Filed: Jul. 22, 2003

(51) Int. Cl. G06F 17/60

(52) U.S. Cl. 705/26

(57) ABSTRACT

An order for a listing of a business in a business directory is received by providing a Web site accessible by a customer and receiving a request from the customer at the Web site to place the order for the listing of the business in the business directory.

### FIELD OF THE INVENTION

The present invention relates generally to computer systems, methods and computer program products and, more particularly, to electronic commerce conducted via computer networks.

### BACKGROUND OF THE INVENTION

Business directories such as Yellow Pages have long been provided as printed publications and, more recently, as “online” (i.e., accessible via the Internet or other computer network) directories (see, for example, realpages.com). Such business directories provide consumers with readily accessible listings and pertinent contact information for businesses of interest. The business listings are often grouped or classified according to the relevant category or categories of products or services offered by the business. Within the groupings and classifications, the listings may be alphabetically or otherwise ordered.

Online directories as mentioned above typically include a listing for each listed business including “basic” information that may include a name, a telephone number, and an address. A listed business may desire to include additional information or features in its listing in order to better inform directory users and/or to stand out more prominently in the directory. The business directory publisher may provide for enhancements to the basic listing or advertisement. While the basic listing may be provided for a charge or free of charge, business directory publishers typically charge additional fees for enhancements, or may not be contacted by large publishers at all because of their size.

Typically, a business directory publisher will solicit listing enhancements by directly contacting businesses (e.g., face to face or via telephone). Because of the costs associated with such sales efforts, sales representatives typically only call upon relatively large businesses of the type that may be expected to invest in and incur the additional expense associated with an enhanced listing. However, there are some smaller businesses that would also like to purchase enhanced listings but are not contacted by sales representatives. Thus, these smaller businesses may not be provided with ready opportunity to order such enhancements, or may not be contacted by large publishers at all because of their size.

### SUMMARY OF THE INVENTION

According to method embodiments of the present invention, a method for receiving an order for a listing of a business in a business directory includes providing a Web site accessible by a customer and receiving a request from the customer at the Web site to place the order for the listing of the business in the business directory.

According to embodiments of the present invention, a system for receiving an order for a listing of a business in a business directory includes a Web site accessible by a customer and means for receiving a request from the customer at the Web site to place the order for the listing of the business in the business directory.

According to further embodiments of the present invention, a computer program product for receiving an order for a listing of a business in a business directory includes a computer readable storage medium having computer readable program code embodied in the medium. The computer readable program code includes computer readable program code configured to provide a Web site accessible by a customer and computer readable program code configured to receive a request from the customer at the Web site to place the order for the listing of the business in the business directory.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

FIG. 1 is a screen capture of a Web page generated according to embodiments of the present invention including a plurality of business listings in a business directory;

FIG. 2 is a further screen capture of a Web page generated according to embodiments of the present invention including additional information relating to an enhanced business listing of the Web page of FIG. 1;

FIG. 3 is a block diagram of a system suitable for use with embodiments of the present invention;

FIG. 4 is a block diagram of data processing systems according to embodiments of the present invention;

FIG. 5 is a more detailed block diagram of data processing systems according to embodiments of the present invention;

FIG. 6A is a flowchart illustrating operations according to embodiments of the present invention;

FIG. 6B is a further flowchart illustrating operations according to embodiments of the present invention;

FIG. 7 is a screen capture of a Web page generated according to embodiments of the present invention;

FIG. 8 is a further screen capture of a Web page generated according to embodiments of the present invention;

FIG. 9 is a further screen capture of a Web page generated according to embodiments of the present invention;

FIG. 10A is a screen capture of a portion of a Web page generated according to embodiments of the present invention;

FIG. 10B is a screen capture of a further portion of the Web page of FIG. 10A;

FIG. 10C is a screen capture of a further portion of the Web page of FIGS. 10A and 10B;

FIG. 11 is a further screen capture of a Web page generated according to embodiments of the present invention;

FIG. 12 is a further screen capture of a Web page generated according to embodiments of the present invention;

FIG. 13 is a further screen capture of a Web page generated according to embodiments of the present invention; and

FIG. 14 is a further screen capture of a Web page generated according to embodiments of the present invention.

### DETAILED DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, a “business directory” is a publication including listings for a plurality of businesses or commercial entities. Each listing may include, for example, the name, address and telephone number of the business. In a business directory, it is the business itself that is listed, not merely a product of the business. The listings may be alphabetically or otherwise organized in the business directory. A “classified business directory” is a business directory wherein businesses are categorized or classified according to the relevant category or categories of products or services offered by the respective businesses. An “online business directory” is a business directory accessible via a computer network such as the Internet.

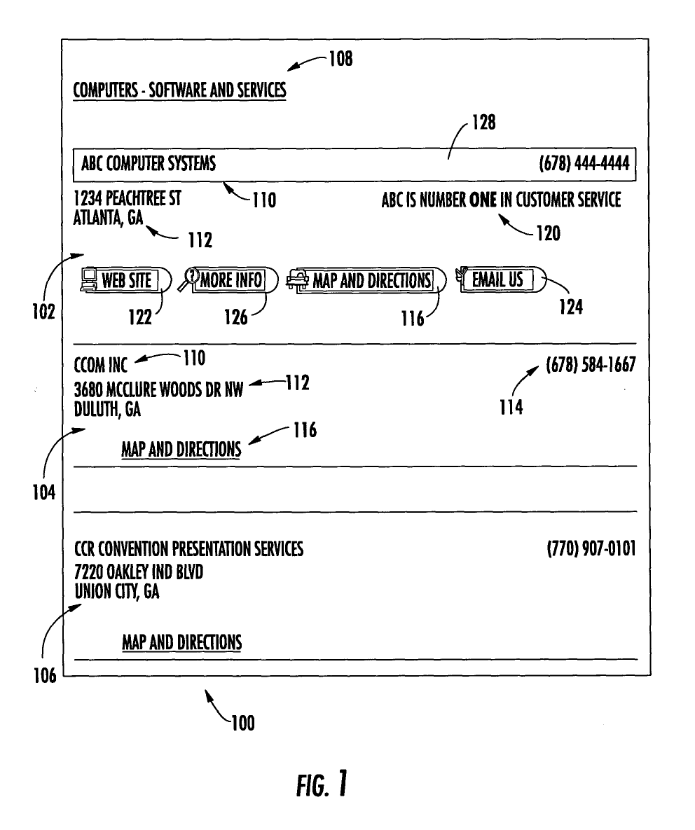

With reference to FIG. 1, an exemplary Web page 100 displaying a portion of an online business directory is shown therein. The Web page 100 includes three business listings 102, 104, 106. The listings 102, 104, 106 are listed under a heading 108 indicating a category within which each of the listings 102, 104, 106 has been classified and grouped. The classification indicates goods or services offered by the businesses listed in the category.

The listings 104, 106 are “basic” listings including a business name 110, a business address 112, and a telephone number 114. A link 116 is provided in each listing 104, 106 which, when “clicked” or selected by a directory user, will transfer the directory user to a Web page displaying a map graphically indicating the geographic location of the business address.

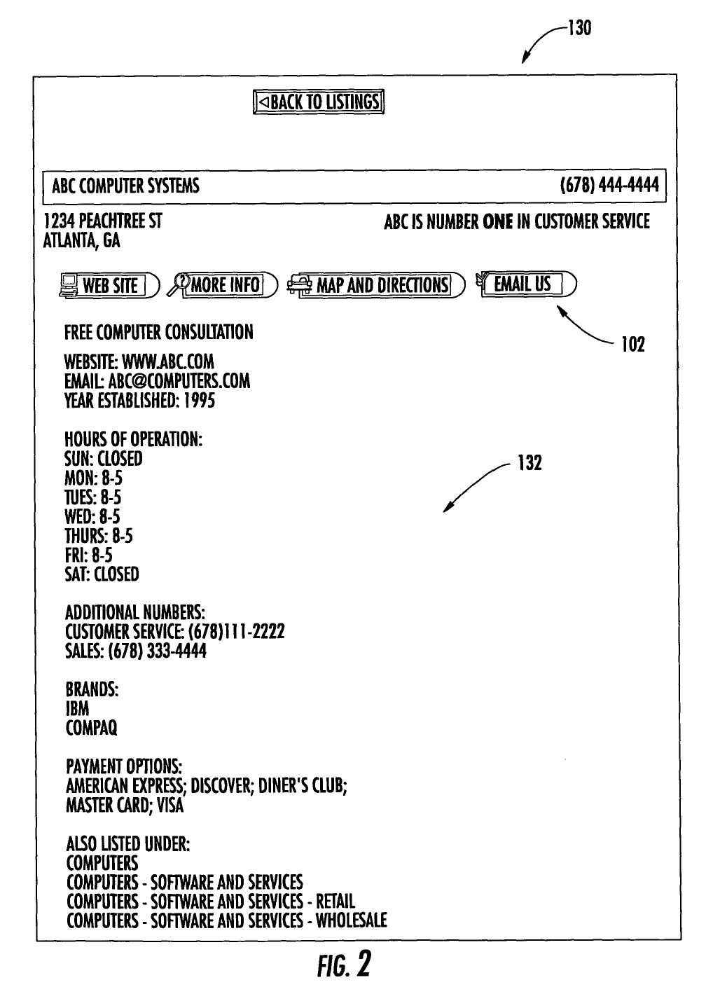

The listing 102 is an “enhanced listing” and may be further characterized as an advertisement. In addition to the business name 110, the business address 112, the business telephone number 114, and the map link 116 of the associated business, the listing 102 includes enhanced text 120 within the body of the listing 102. The listing 102 further includes a “Web site” link button 122 that will transfer the directory user to a Web site of the business (e.g., the business' homepage) when pressed by the user. The listing 102 also includes an “e-mail” link button 124 that will generate an e-mail template preaddressed to a prescribed e-mail address of the business when the button 124 is pressed by the user. A “more info” link button 126 is provided to transfer the directory user to an “info plus” Web page 130 (as shown in FIG. 2) including the enhanced listing 102 and additional information 132. Furthermore, the enhanced listing 102 is readily visually distinguishable from the basic listings 104, 106 by highlighting 128, which may include optical shading (for example, of a bright yellow color) or the like. The highlighting may extend throughout the listing 102 or be otherwise patterned.

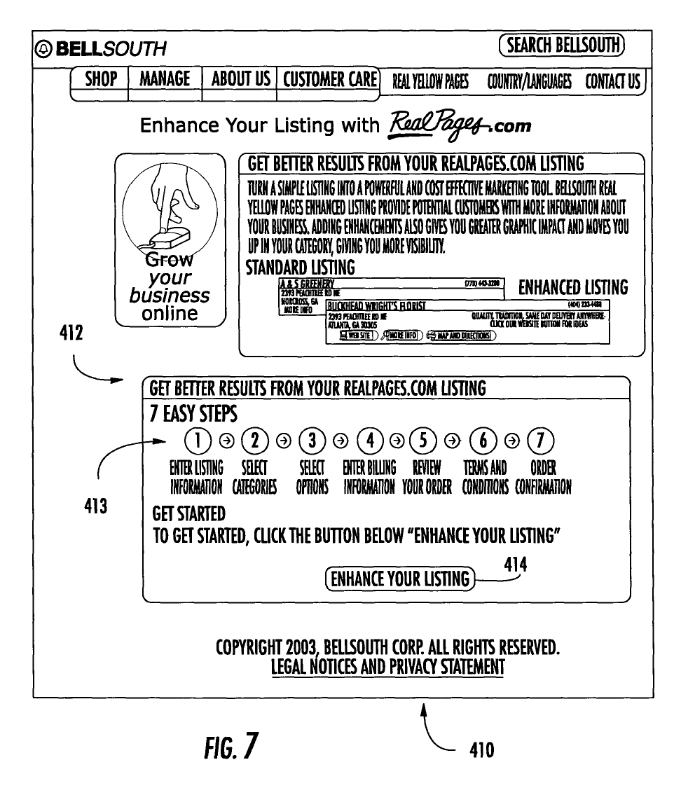

According to some embodiments of the invention, the systems, methods and computer program products of the present invention may be used to receive orders for basic listings (e.g., the listings 104, 106) and/or enhanced listings (e.g., the listing 102). According to further embodiments, the systems, methods and computer program products are adapted to enhance existing basic listings in a business directory. For example, the business directory may be an online business directory and the data for the basic listings may be sourced from another directory (e.g., a printed or hard copy business directory publication). According to some embodiments, the systems, methods and computer program products may be adapted to only receive orders for new enhanced listings or enhancements to existing listings. The following description describes systems, methods and computer program products as employed for receiving an order for the enhanced listing 102. However, it will be appreciated by those of skill in the art that differently configured listings may be ordered using the systems, methods and computer program products according to the present invention, it being understood that the Web pages as shown in FIGS. 7-14 and the listing 102 (as well as the info plus Web page 130) are merely exemplary of listings and Web pages which may be ordered and generated in accordance with the present invention.

A preferred communications network with which the present invention may be utilized is the Internet. The Internet is a worldwide decentralized network of computers having the ability to communicate with each other. The Internet has gained broad recognition as a viable medium for communicating and for conducting business. The World-Wide Web (Web) is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device, and/or between wireless client/devices and Wireless Application Protocol (WAP) server devices. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), Wireless Markup Language (WML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and which may or may not be geographically-dispersed. For example, the Web site of the International Business Machines Corporation (ibm.com) consists of thousands of Web pages and files spread out over multiple Web servers in locations world-wide.

A Web server (also referred to as an HTTP server) is a computer program that utilizes HTTP to serve files that form Web pages to requesting Web clients. Exemplary Web servers include International Business Machines Corporation's family of Lotus Domino® servers, the Apache server (available from apache.org), and Microsoft's Internet Information Server (IIS), available from Microsoft Corporation, Redmond, Wash. A Web client is a requesting program that also utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders within a display screen. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized by users accessing a Web site according to the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects (i.e., activates) a particular hypertext link, a browser running on the user's client device reads and interprets an address, called a Uniform Resource Locator (URL) associated with the hypertext link, connects the browser with a Web server at that address, and makes a request (e.g., an HTTP request) for the file identified in the hypertext link. The Web server then sends the requested file to the client device, which the browser interprets and renders within a display screen.

As will be appreciated by those of skill in the art, the present invention may be embodied as methods, data processing systems, or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language, or in a functional (or fourth generation) programming language such as Lisp, SML, or Forth. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to an embodiment of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

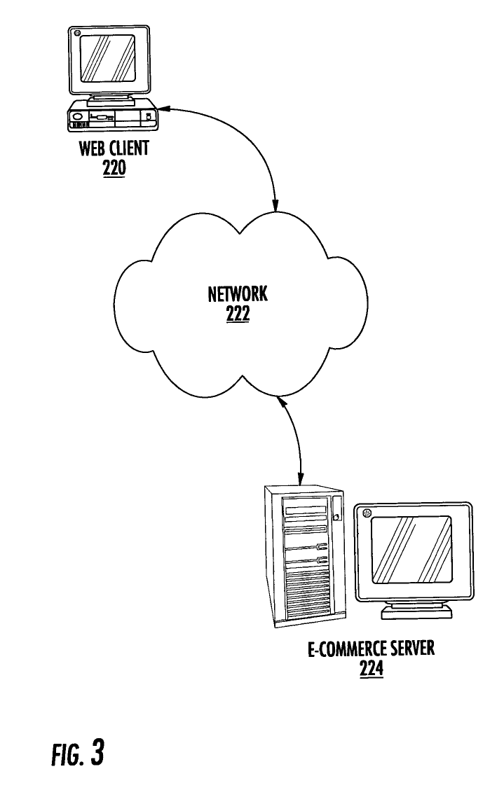

Referring now to FIG. 3, a system suitable for use with various embodiments of the present invention is illustrated. As seen in FIG. 3, a web client data processing system 220 may communicate over a network 222 with a server, such as the e-commerce server 224 illustrated in FIG. 3. The e-commerce server 224 may provide Web pages, applets or other such programs to the web client 220 over network 222. The network 222 may be the Internet or an intranet or a combination of the two and may include various types of communications including communications over telephone lines, wireless communications, local area network (LAN) or wide area network (WAN) communications or the like.

In operation, the e-commerce server 224 provides a Web page containing images adapted to instruct and solicit information and instructions from a customer. The web client 220 displays the Web pages and a user selects options and provided information through selective manipulation of buttons and the like and entry of data into selected fields.

The e-commerce server 224 may provide to a web client 220 browser interpretable pages such as HTML pages, dynamic HTML (DHTML) pages or Extensible Markup Language (XML) pages which may display information for on-line transactions. As will be appreciated by those of skill in the art, the web client 220 may be any user workstation or device capable of rendering the browser interpretable pages such as, for example, a personal computer or a network computer or even pervasive computing devices such as a personal data assistant (PDA) or a smartphone. Furthermore, the term browser is used herein to refer to any application, program, hardware or other device that may interpret and display a browser interpretable page such as an HTML or XML page. Accordingly, the present invention should not be construed as limited to any particular workstation or browser implementation. Furthermore, the present invention may be applicable to a number of different architectures and, thus, should not be construed as limited to the particular configuration illustrated in FIG. 3, but may be utilized with any configuration suitable for carrying out the operations described herein.

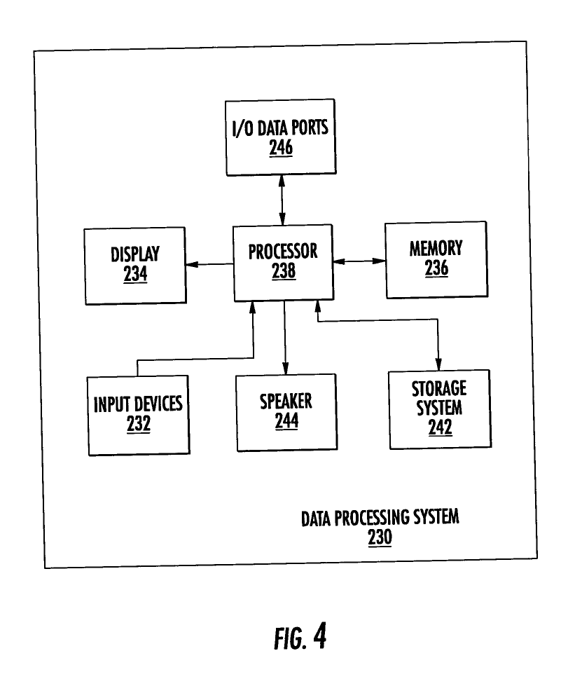

Referring now to FIG. 4, an exemplary embodiment of a data processing system 230 suitable for use as a web client 220 and/or an e-commerce server 224 in accordance with embodiments of the present invention is illustrated and may include input device(s) 232 such as a keyboard or keypad, a display 234, and a memory 236 that communicate with a processor 238. The data processing system 230 may further include a storage system 242, a speaker 244 and an I/O data port(s) 246 that also communicate with the processor 238. The storage system 242 may include removable and/or fixed media such as floppy disks, ZIP drives, hard disks or the like as well as virtual storage such as a RAMDISK. The I/O data port 246 can be used to transfer information between the data processing system 230 and another computer system or a network (e.g., the Internet). Such data processing systems may include, for example, personal computers, laptop computers, mainframe computers, pervasive computing devices such as personal digital assistants, smartphones or the like, or even embedded processing systems. The components of a particular data processing system may be conventional or custom components, such as those used in many conventional computing devices, which may be configured to operate as described herein.

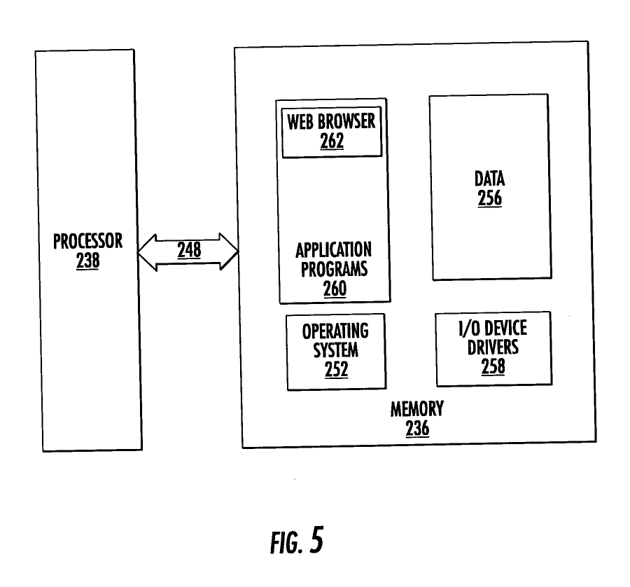

FIG. 5 is a block diagram of data processing systems that illustrate systems, methods, and computer program products in accordance with embodiments of the present invention. The processor 238 communicates with the memory 236 via an address/data bus 248. The processor 238 can be a commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIG. 5, the memory 236 may contain several categories of software and data used in the data processing system 230: the operating system 252; the application program(s) 260; the input/output (I/O) device drivers 258; and the data 256. As will be appreciated by those of skill in the art, the operating system 252 may be any operating system suitable for use with a data processing system, such as OS/2, AIX or OS/390 from International Business Machines Corporation, Armonk, N.Y., WindowsCE, WindowsNT, Windows₉₅, Windows98 or Windows2000 from Microsoft Corporation, Redmond, Wash., PalmOS from Palm, Inc., MacOS from Apple Computer, UNIX or Linux, proprietary operating systems or dedicated operating systems, for example, for embedded data processing systems.

The I/O device drivers 258 typically include software routines accessed through the operating system 252 by the application program 260 to communicate with devices such as the input devices 232, the display 234, the speaker 244, the storage system 242, the I/O data port(s) 246, and certain memory 236 components. The application program(s) 260 is illustrative of the programs that implement the various features of the data processing system 230. Finally, the data 256 represents the static and dynamic data used by the application program(s) 260, operating system 252, I/O device drivers 258, and other software programs that may reside in the memory 236.

As is further seen in FIG. 5, the application program(s) 260 may include a web browser 262. The web browser 262 may be any conventional web browser capable of being configured to carry out the operations described herein. The present invention should not be construed as limited to the configuration of FIG. 5 but may encompass any suitable architecture, programming language or division of function which may carry out the operations described herein for ordering a listing in a business directory. While the present invention is illustrated, for example, with reference to a web browser 262, as will be appreciated by those of skill in the art, the functions carried out by these modules may also be incorporated into for example, the operating system 252. Thus, the present invention should not be construed as limited to the configuration of FIG. 5 but is intended to encompass any configuration capable of carrying out the operations described herein.

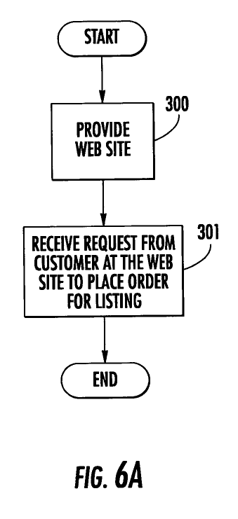

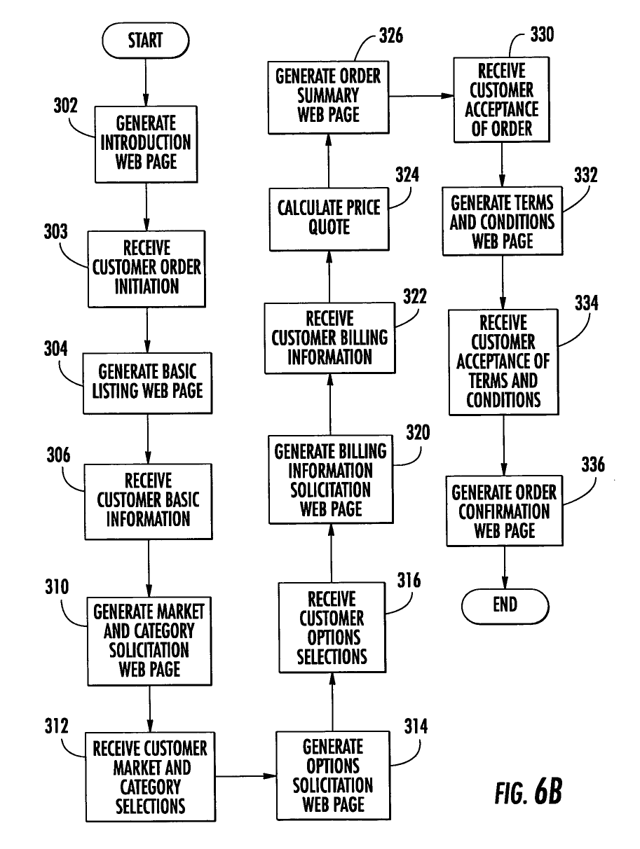

FIGS. 6A and 6B are a flow charts illustrating the methods, systems, and computer program products according to certain embodiments of the present invention. It will be understood that each step of each flow chart, and combinations of the steps in the flow chart diagram, can be implemented by computer program instructions. These computer program instructions may be loaded onto a computer or other programmable data processing apparatus to produce a machine such that the instructions which execute on the computer or other programmable apparatus create means for implementing the functions specified in the flow chart step(s). These computer program instructions may also be stored in a computer readable memory that can direct a computer or other programmable apparatus to function in a particular manner, such that the instructions stored in the computer readable memory produce an article of manufacture including instruction means which implement the functions specified in the flow chart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart step(s).

Accordingly, steps of the flow chart illustrations support combinations of means for performing the specified functions, combinations of steps for performing the specified functions and program instruction means for performing the specified function. It will also be understood that each step of the flow chart illustrations, and combinations of steps in the flow chart illustrations, can be implemented by special purpose hardware based computer systems which perform the specified functions or steps, or combinations of special purpose hardware and computer instructions.

Referring now to FIG. 6A, a flow chart illustrating operations of the present invention for receiving an order for a listing of a business in a business directory will now be described. The questions include providing a Web site that is accessible by the customer (Block 300). The system then receives a request from the customer at the Web site to place the order for the listing of the business in the business directory (Block 301).

Referring now to FIG. 6B, a flowchart illustrating operations of the present invention for receiving an order for a business directory listing in accordance with more particular embodiments of the present invention will now be described. Processing begins with the generation of a home page or introduction Web page 410 as shown in FIG. 7 (Block 302). The introduction Web page 410 may be accessed by the customer by entering a corresponding Web address (e.g., URL) in the browser of the web client and directing the browser to the address. Alternatively, the customer may access the introduction Web page 410 by actuating a link on an associated Web page that transfers the customer to the Web page 410.

The introduction Web page 410 may include a graphical and textual description 412 of enhanced listings and an overview of the ordering process. According to some embodiments, the description 412 includes a graphical model or representation 413 of the step-by-step process described hereinbelow. The description 412 may include advertising copy and instructions to proceed by clicking a button 414. The customer initiates the ordering procedure by clicking the button 414, which command is received by the system (Block 303).

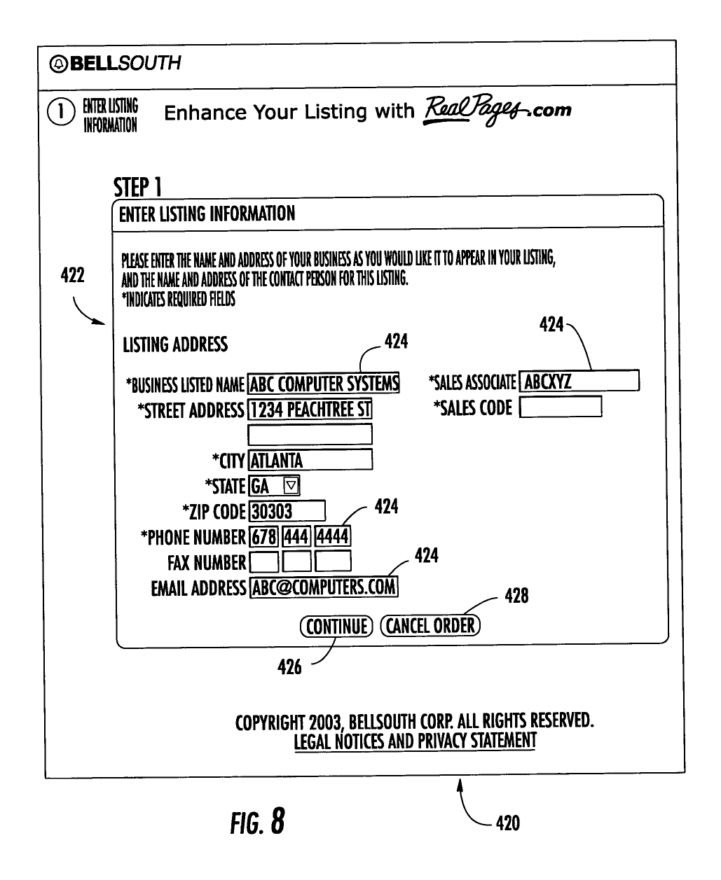

Responsive to actuation of the button 414, a basic listing Web page 420 (FIG. 8) is generated (Block 304). The Web page 420 includes instructions 422 directing the customer to enter appropriate data in data entry fields 424 of the Web page 420. As illustrated, the information to be entered by the customer includes the name of the business, the business address, the business telephone number, the business e-mail address, and the name of a contact person for the listing. The customer may abort the order process by clicking or pressing a button 428. Alternatively, once the required information has been entered in the fields of the Web page 420, the user can continue to the next step by pressing the button 426 to send the information to the system (Block 306).

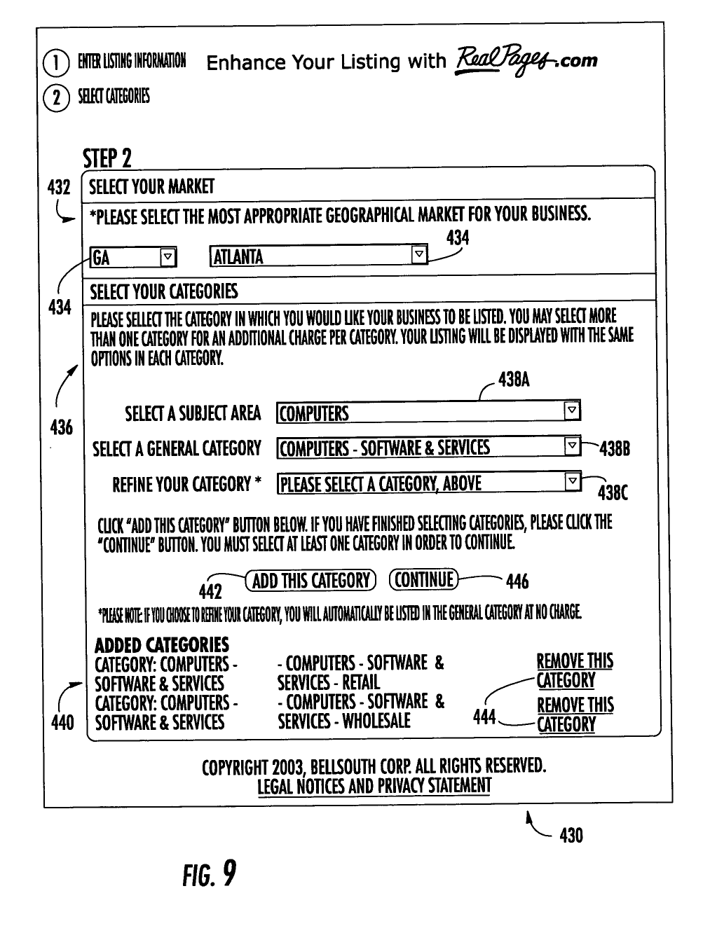

Responsive to the customer's pressing of the button 426, a market and category solicitation Web page 430 (FIG. 9) is generated (Block 310). The Web page 430 includes instructions 432 to select the appropriate region or market (e.g., the geographical market) for the customer's business from pull down menus 434. The available regions or markets are typically defined by the directory publisher. The Web page 430 further includes instructions 436 instructing the customer to select the category or categories within which the customer wishes to have the customer's business listed in the classifications or groupings of the business directory. According to some embodiments and as illustrated, the category selection process is a tiered process. The listing will appear in each of the categories and subcategories selected. The customer first selects a subject area from one of several available subject areas or headings using the pull down menu 438A. Related general categories are then made available for selection using the pull down menu 438B. Once a general category has been selected by the customer, further subcategories are enabled for selection using the pull down menu 438C. Once a desired category or subcategory has been selected, the user clicks the button 442 to add the category to the listing order. The user may continue this process until all desired categories have been selected. If necessary, the customer can remove a category using the associated button 444. After the customer has completed selection of the desired categories, the user clicks the button 446 to continue and submit the business market information and business category information to the system (Block 312).

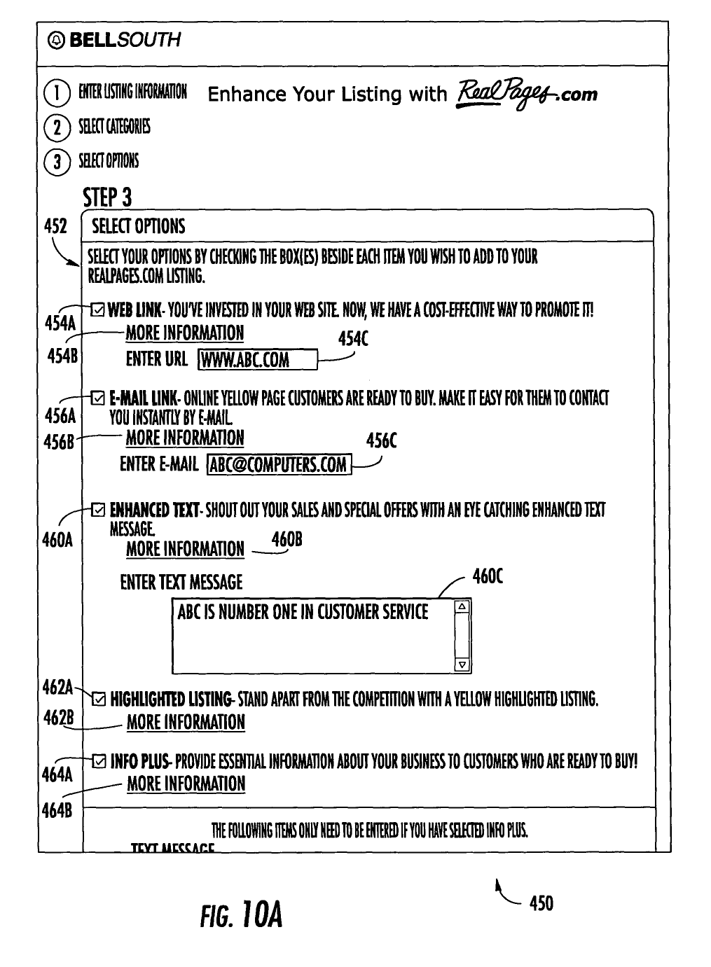

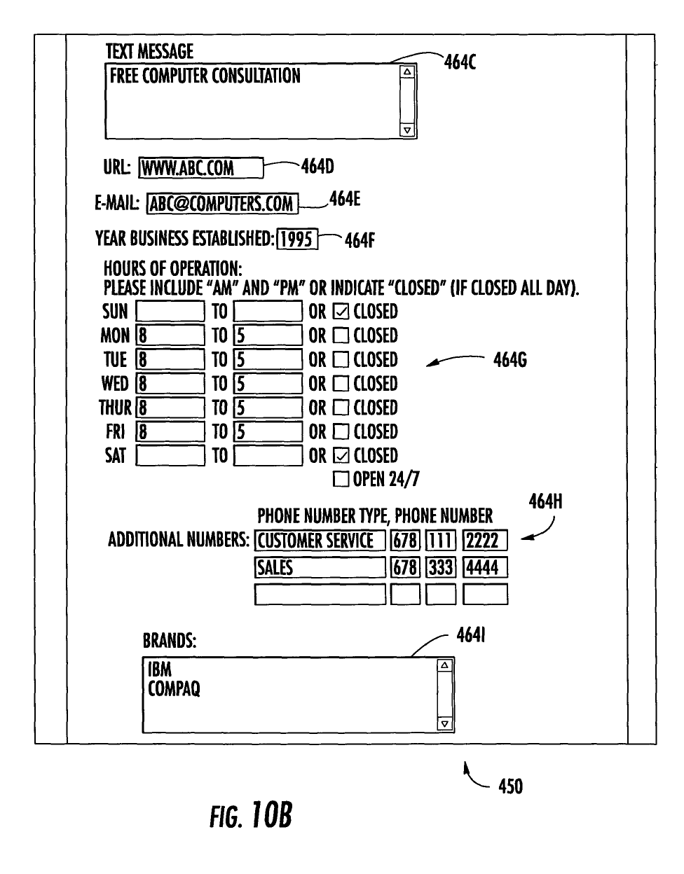

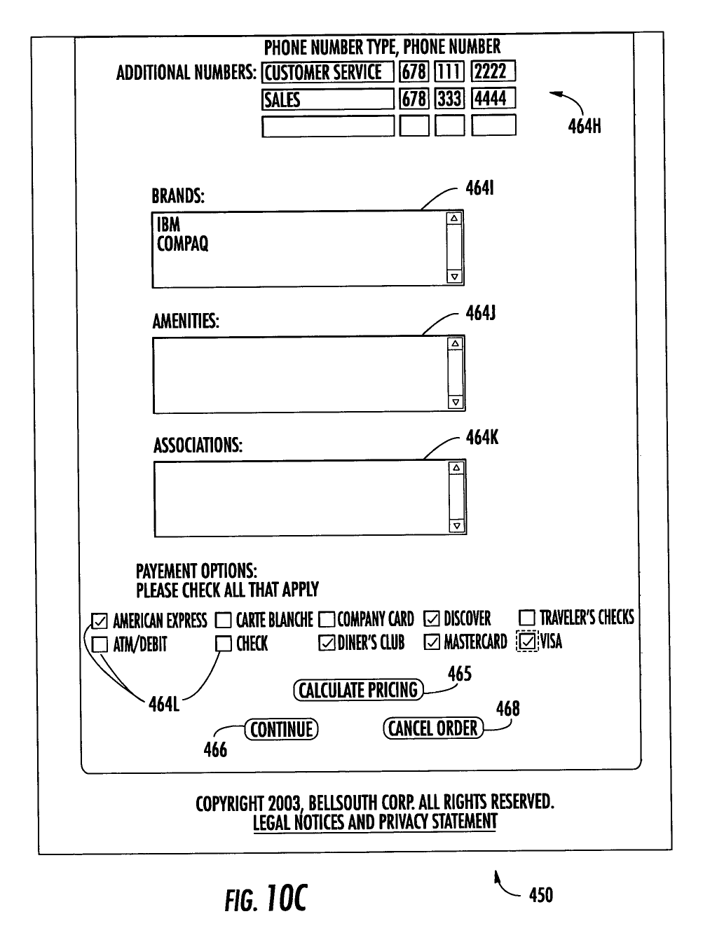

With reference to FIGS. 10A-10B, responsive to the customer's clicking of the button 446, an options solicitation Web page 450 is generated (Block 314). The Web page 450 may be a single extended Web page 450 as shown (FIGS. 10A, 10B and 10C show various sequential portions of a common Web page 450), or may be broken into multiple Web pages. The options solicitation Web page 450 includes instructions 452 to the customer. The customer may select the desired options by clicking and thereby checking the associated boxes 454A, 456A, 460A, 462A, 464A. The customer can obtain a further description of each option by clicking a respective associated link 454B, 456B, 460B, 464B.

By clicking the box 454A, the customer selects the Web link option, which corresponds to the Web site link button 122 (and the associated functionality) of the listing 102 (FIG. 1). The customer must enter the desired Web site address in the data entry field 454C.

By clicking the box 456A, the customer selects the e-mail link option, which corresponds to the e-mail link button 124 (and the associated functionality) of the listing 102. The customer must enter the desired e-mail address in the data entry field 456C.

By clicking the box 460A, the customer selects the enhanced text option, which corresponds to the enhanced text 120 of the listing 102. The customer must enter the desired text in the data entry field 460C.

By clicking the box 462A, the customer selects the highlighted listing option, which corresponds to the highlighting 128 of the listing 102.

By clicking the box 462A, the customer selects the info plus option, which corresponds to the “more info” button 122 and the info plus Web page 130 (FIG. 2). When this option is selected, the customer may provide various supplemental information for inclusion in the info plus Web page 130, as outlined in the remainder of the options Web page 450. For example, the customer may include a text message in the listing by entering text in the data entry field 464C. The customer may provide a Web site address and an e-mail address by entering the same in the data entry fields 464D and 464E, respectively. The customer may advertise its year of business establishment by entering the appropriate year in the data entry field 464F. The customer may indicate the business's hours of operation by entering the same in the data entry fields and boxes 464G. The customer may provide additional telephone numbers on the info plus Web page 130 by entering the same in the data entry fields 464H. The customer may indicate various additional information on the info plus Web page 130 by entering the information in the data entry fields 464I (for a listing of brands serviced, offered or the like), 464J (for amenities offered), and 464K (for associations to which the business belongs). The customer may further set forth on the info plus Web page 130 a listing of payment types accepted by checking the appropriate boxes 464L.

If desired, the customer may obtain a provisional price quote for the options and categories thus far selected by clicking the button 465. The customer may abort the order in process by clicking the button 468. If the customer is satisfied with the order thus far, the customer can click the button 466 to send the options selections and related data or enhancement information to the system (Block 316).

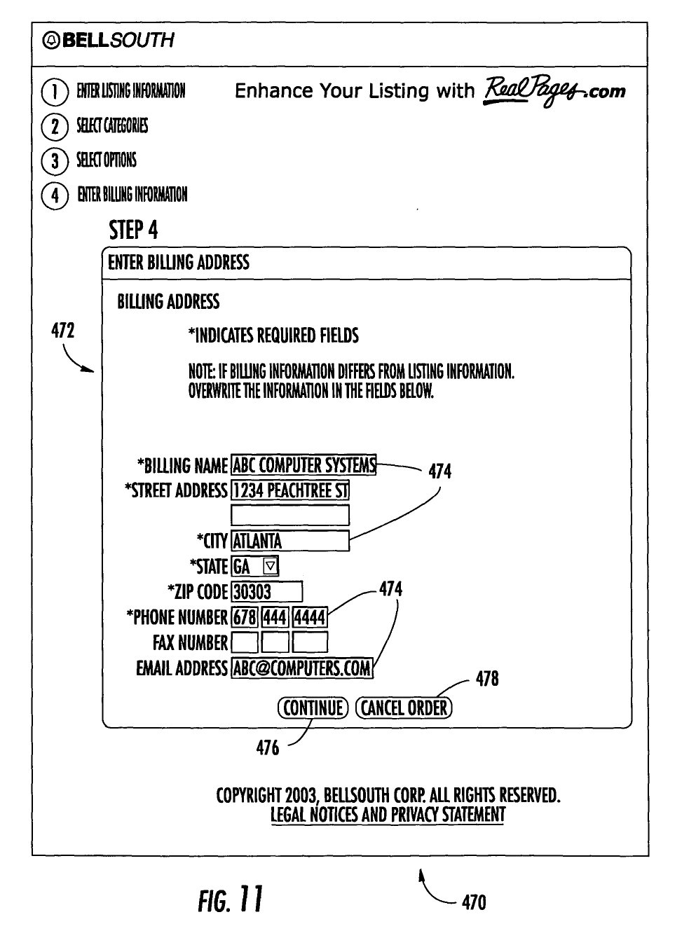

Responsive to the customer's clicking of the button 466, a billing information solicitation Web page 470 (FIG. 11) is generated (Block 320). The billing solicitation Web page 470 includes instructions 472 directing the customer to enter billing data in data entry fields 474. The customer may abort the order process by clicking the button 478. Alternatively, the customer may proceed with the process by clicking the button 476, whereupon the billing information entered in the data entry fields 474 is submitted to the system (Block 322).

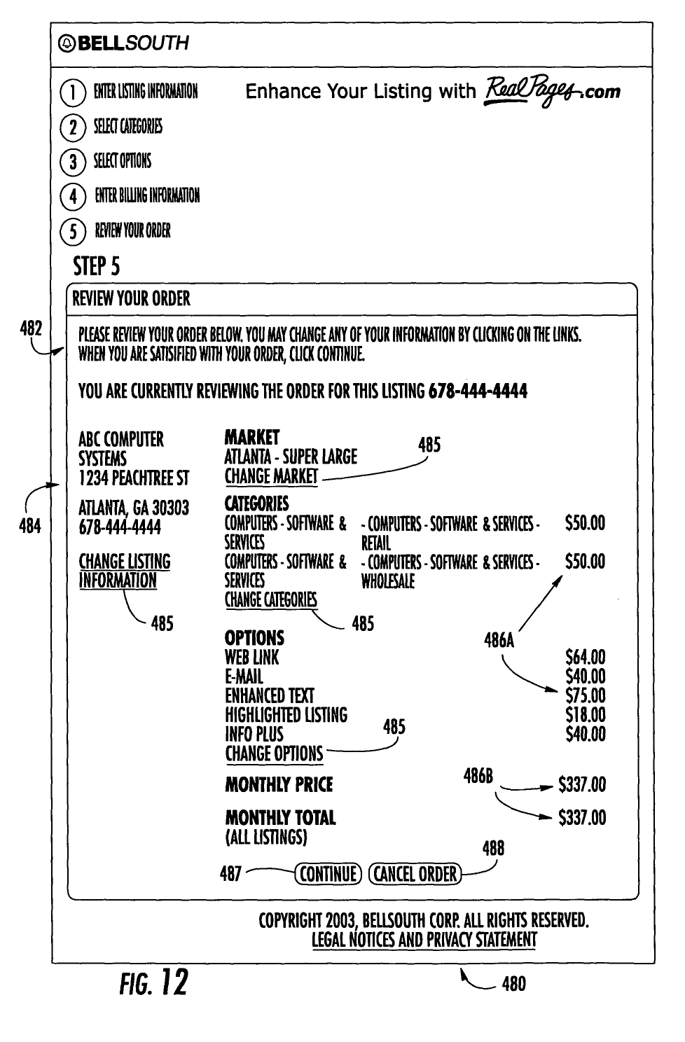

Responsive to the user's clicking the button 476, the system calculates a price quote for the categories and options selected (Block 324). The system then generates an order summary Web page 480 (FIG. 12) (Block 326). The order summary Web page 480 includes instructions 482 to the customer directing the customer to review his or her order. The Web page 480 further includes a listing 484 of all of the basic listing data, market selection, selected categories, and selected options. The Web page 480 also includes an itemized listing 486A of the costs associated with each of the selected categories and options, as well as a total cost 486B. Links 485 are provided on the Web page 480 to allow the customer to return to the appropriate Web page 410, 420, 430, 450, 470 to modify the data previously entered or selections previously made. The customer may abort the order by clicking the button 488. Alternatively, the customer may submit his or her acceptance of the order to the system by clicking the button 487 (Block 330).

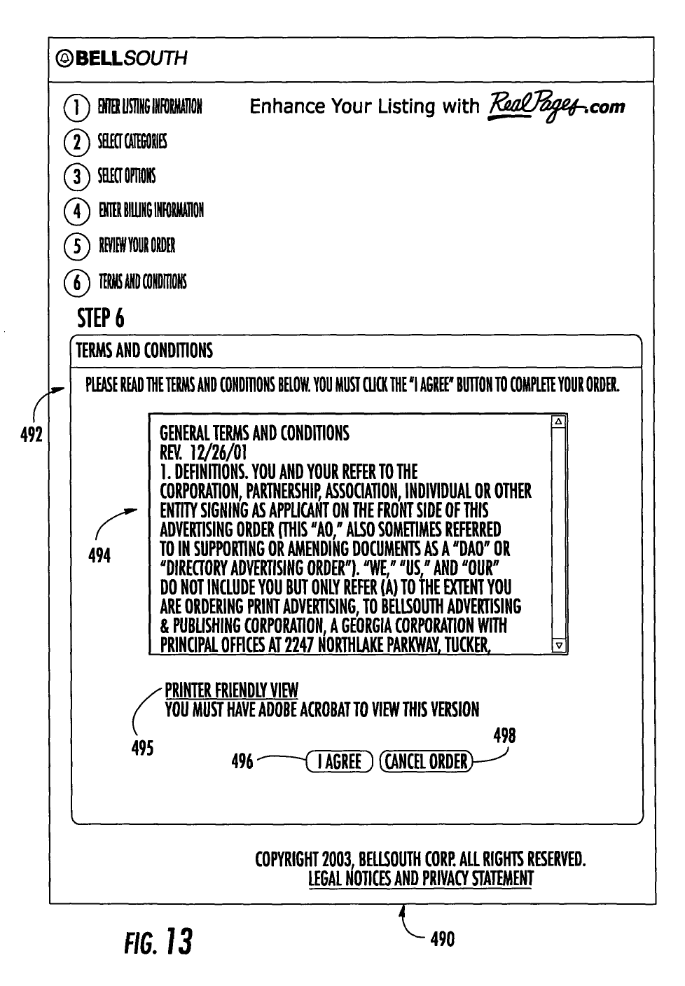

Responsive to the customer's clicking the button 487, a terms and conditions Web page 490 (FIG. 13) is generated (Block 332). The Web page 490 includes instructions 492 to the user to read the conditions under which the listing is offered, as well as a window 494 (which may be scrollable, as illustrated) including a listing of the terms and conditions. A link 495 may be provided to allow the customer to download a printer friendly (e.g., .pdf) electronic copy of the terms and conditions shown in the window 494. The user may abort the order by clicking the button 498. Alternatively, the user may click the button 496 to submit his or her agreement to the terms and conditions to the system (Block 334).

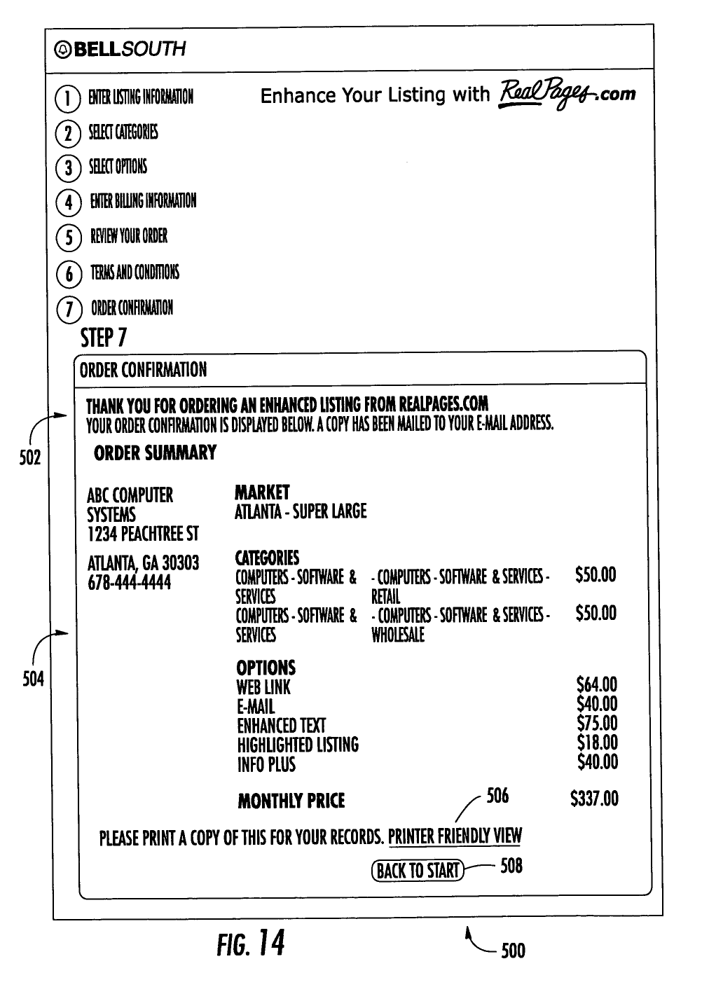

Responsive to the user's clicking the button 496, an order confirmation Web page 500 (FIG. 14) is generated (Block 336). The Web page 500 includes an indication to the customer that the order has been confirmed, as well as any related information. According to some embodiments, a copy of the confirmation will be mailed to the customer's e-mail address, as previously entered by the customer. The Web page 500 further includes a listing 504 of the information previously provided on the summary Web page 480. Again, a link 506 is provided to allow the customer to download a printer friendly electronic copy of the order confirmation. The customer may return to the introduction Web page 410 by clicking a button 508 in order to begin the order process for a further listing in the business directory.

The information collected from the customer during the ordering process (e.g., the basic listing data, the market and category selections, and the options data and selections) may thereafter be compiled and automatically, semi-automatically, or manually formatted to form the listing 102. According to some embodiments, the information is provided to a directory associate who manually formats and edits the data and selections as appropriate to configure a draft listing or “proof”, and thereafter submits the draft listing for inclusion in the business directory. Optionally, the draft listing may be forwarded to the customer for review prior to publication in the business directory.

As will be appreciated from the foregoing description, the customer need not select and include all of the available options. Additional options may be made available. Certain basic features may be provided instead as optional enhancements (e.g., the map link) or vice-versa.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A method for receiving an order for a listing of a business in a business directory, the method comprising:
providing a Web site accessible by a customer; and
receiving a request from the customer at the Web site to place the order for the listing of the business in the business directory.

2. The method of claim 1 wherein the business directory is a classified business directory.

3. The method of claim 1 further comprising displaying to the customer at the Web site a solicitation to enhance the listing with at least one optional listing enhancement, wherein the at least one optional listing enhancement can be purchased with an associated fee.

4. The method of claim 3 further comprising receiving listing information from the customer at the Web site, wherein the listing information includes basic business information including a business name, a business address, and a business telephone number.

5. The method of claim 1 further comprising:
displaying at the Web site a list of available optional listing enhancements; and
receiving from the customer at the Web site a selection of at least one optional listing enhancement from the list of available optional listing enhancements.

6. The method of claim 1 further comprising receiving listing information from the customer at the Web site, the listing information including at least one of business market information, business category information and optional listing enhancement information relating to the placement and/or appearance of the listing in the business directory.

7. The method of claim 6 wherein the listing information further includes basic business information including a business name, a business address, and a business telephone number.

8. The method of claim 6 wherein the listing information includes business market information, the business market information including a region or market in which the customer wishes the business listing to appear.

9. The method of claim 6 wherein the listing information includes business category information, the business category information including at least one business category under which the customer wishes to list the business in the business directory.

10. The method of claim 9 wherein the business category information includes at least two categories under which the customer wishes to list the business in the business directory.

11. The method of claim 9 further comprising:
displaying at the Web site a list of available business categories; and
receiving from the customer at the Web site a selection of a business category from the list of available business categories.

12. The method of claim 11 further comprising:
displaying at the Web site a list of available business subcategories within the business category selected by the customer; and
receiving from the customer at the Web site a selection of a business subcategory from the list of available business subcategories.

13. The method of claim 6 wherein the listing information includes optional listing enhancement information and the optional listing enhancement information includes graphical and/or textual indicia the customer wishes to appear on the listing in the business directory, the graphical and/or textual indicia including at least one of a customer Web site link, a customer email link, enhanced text, listing highlighting, and a link to a supplemental listing.

14. The method of claim 13 wherein the graphical and/or textual indicia includes a link to an enhanced listing, the method further including receiving supplemental information from the customer at the Web site that the customer wishes to be displayed when the link to the supplemental listing is accessed by a directory user.

15. The method of claim 13 wherein the graphical and/or textual indicia includes enhanced text, the method further including receiving enhanced text information from the customer at the Web site that the customer wishes to appear on the listing in the business directory.

16. The method of claim 1 further comprising receiving billing information from the customer at the Web site.

17. The method of claim 1 further comprising generating a price quote for the business listing ordered by the customer and displaying the price quote to the customer at the Web site.

18. The method of claim 17 wherein the step of generating the price quote includes calculating the price quote based on features requested by the customer to be included in the business listing.

19. The method of claim 1 further comprising:
displaying a statement of terms and conditions to the customer at the Web site; and
receiving confirmation of acceptance of the terms and conditions from the customer at the Web site.

20. The method of claim 1 further comprising generating an order confirmation and displaying the order confirmation to the customer at the Web site.

21. The method of claim 1 wherein the order serves to provide enhancements to an existing business listing in the business directory.

22. The method of claim 1 wherein the business directory is an online business directory.

23. The method of claim 1 further comprising sending the customer an email including information regarding the order for the listing in the business directory.

24. The method of claim 1 wherein the business directory is a classified business directory, the method further comprising:
receiving listing information from the customer at the Web site, the listing information including:
basic business information including a business name, a business address, and a business telephone number; and
at least one of business market information, business category information and optional listing enhancement information relating to the placement and/or appearance of the listing in the classified business directory;
receiving billing information from the customer at the Web site;
generating a price quote for the business listing ordered by the customer and displaying the price quote to the customer at the Web site, the step of generating the price quote including calculating the price quote based on features requested by the customer to be included in the business listing; and
generating an order confirmation and displaying the order confirmation to the customer at the Web site.

25. The method of claim 24 wherein the listing information includes business market information, the business market information including a region or market in which the customer wishes the business listing to appear.

26. The method of claim 24 wherein the listing information includes business category information, the business category information including at least one business category under which the customer wishes to list the business in the classified business directory.

27. The method of claim 24 wherein the listing information includes optional listing enhancement information and the optional listing enhancement information includes graphical and/or textual indicia the customer wishes to appear on the listing in the classified business directory, the graphical and/or textual indicia including at least one of a customer Web site link, a customer email link, enhanced text, listing highlighting, and a link to a supplemental listing.

28. The method of claim 24 wherein the classified business directory is an online classified business directory.

29. A system for receiving an order for a listing of a business in a business directory, the system comprising:
a Web site accessible by a customer; and
means for receiving a request from the customer at the Web site to place the order for the listing of the business in the business directory.

30. The system of claim 29 wherein the business directory is a classified business directory.

31. The system of claim 29 further comprising means for displaying to the customer at the Web site a solicitation to enhance the listing with at least one optional listing enhancement, wherein the at least one optional listing enhancement can be purchased with an associated fee.

32. The system of claim 31 further comprising means for receiving listing information from the customer at the Web site, wherein the listing information includes basic business information including a business name, a business address, and a business telephone number.

33. The system of claim 29 further comprising:
means for displaying at the Web site a list of available optional listing enhancements; and
means for receiving from the customer at the Web site a selection of at least one optional listing enhancement from the list of available optional listing enhancements.

34. The system of claim 29 further comprising means for receiving listing information from the customer at the Web site, the listing information including at least one of business market information, business category information and optional listing enhancement information relating to the placement and/or appearance of the listing in the business directory.

35. The system of claim 34 wherein the listing information further includes basic business information including a business name, a business address, and a business telephone number.

36. The system of claim 34 wherein the listing information includes business market information, the business market information including a region or market in which the customer wishes the business listing to appear.

37. The system of claim 34 wherein the listing information includes business category information, the business category information including at least one business category under which the customer wishes to list the business in the business directory.

38. The system of claim 37 wherein the business category information includes at least two categories under which the customer wishes to list the business in the business directory.

39. The system of claim 37 further comprising:
means for displaying at the Web site a list of available business categories; and
means for receiving from the customer at the Web site a selection of a business category from the list of available business categories.

40. The system of claim 39 further comprising:
means for displaying at the Web site a list of available business subcategories within the business category selected by the customer; and
means for receiving from the customer at the Web site a selection of a business subcategory from the list of available business subcategories.

41. The system of claim 34 wherein the listing information includes optional listing enhancement information and the optional listing enhancement information includes graphical and/or textual indicia the customer wishes to appear on the listing in the business directory, the graphical and/or textual indicia including at least one of a customer Web site link, a customer email link, enhanced text, listing highlighting, and a link to a supplemental listing.

42. The system of claim 41 wherein the graphical and/or textual indicia includes a link to an enhanced listing, the system further including means for receiving supplemental information from the customer at the Web site that the customer wishes to be displayed when the link to the supplemental listing is accessed by a directory user.

43. The system of claim 41 wherein the graphical and/or textual indicia includes enhanced text, the system further including means for receiving enhanced text information from the customer at the Web site that the customer wishes to appear on the listing in the business directory.

44. The system of claim 29 further comprising means for receiving billing information from the customer at the Web site.

45. The system of claim 29 further comprising means for generating a price quote for the business listing ordered by the customer and displaying the price quote to the customer at the Web site.

46. The system of claim 45 wherein the means for generating the price quote includes means for calculating the price quote based on features requested by the customer to be included in the business listing.

47. The system of claim 29 further comprising:
means for displaying a statement of terms and conditions to the customer at the Web site; and
means for receiving confirmation of acceptance of the terms and conditions from the customer at the Web site.

48. The system of claim 29 further comprising means for generating an order confirmation and displaying the order confirmation to the customer at the Web site.

49. The system of claim 29 wherein the order serves to provide enhancements to an existing business listing in the business directory.

50. The system of claim 29 wherein the business directory is an online business directory.

51. The system of claim 29 further comprising means for sending the customer an email including information regarding the order for the listing in the business directory.

52. The system of claim 29 wherein the business directory is a classified business directory, the system further comprising:
means for receiving listing information from the customer at the Web site, the listing information including:
basic business information including a business name, a business address, and a business telephone number; and
at least one of business market information, business category information and optional listing enhancement information relating to the placement and/or appearance of the listing in the classified business directory;
means for receiving billing information from the customer at the Web site;
means for generating a price quote for the business listing ordered by the customer and displaying the price quote to the customer at the Web site, wherein the means for generating the price quote includes means for calculating the price quote based on features requested by the customer to be included in the business listing; and
means for generating an order confirmation and displaying the order confirmation to the customer at the Web site.

53. The system of claim 52 wherein the listing information includes business market information, the business market information including a region or market in which the customer wishes the business listing to appear.

54. The system of claim 52 wherein the listing information includes business category information, the business category information including at least one business category under which the customer wishes to list the business in the classified business directory.

55. The system of claim 52 wherein the listing information includes optional listing enhancement information and the optional listing enhancement information includes graphical and/or textual indicia the customer wishes to appear on the listing in the classified business directory, the graphical and/or textual indicia including at least one of a customer Web site link, a customer email link, enhanced text, listing highlighting, and a link to a supplemental listing.

56. The system of claim 52 wherein the classified business directory is an online classified business directory.

57. A computer program product for receiving an order for a listing of a business in a business directory, the computer program product comprising:
a computer readable storage medium having computer readable program code embodied in the medium, the computer readable program code comprising:
computer readable program code configured to provide a Web site accessible by a customer; and
computer readable program code configured to receive a request from the customer at the Web site to place the order for the listing of the business in the business directory.

58. The computer program product of claim 57 wherein the business directory is a classified business directory.

59. The computer program product of claim 57 further comprising computer readable program code configured to display to the customer at the Web site a solicitation to enhance the listing with at least one optional listing enhancement, wherein the at least one optional listing enhancement can be purchased with an associated fee.

60. The computer program product of claim 59 further comprising computer readable program code configured to receive listing information from the customer at the Web site, wherein the listing information includes basic business information including a business name, a business address, and a business telephone number.

61. The computer program product of claim 57 further comprising:
computer readable program code configured to display at the Web site a list of available optional listing enhancements; and
computer readable program code configured to receive from the customer at the Web site a selection of at least one optional listing enhancement from the list of available optional listing enhancements.

62. The computer program product of claim 57 further comprising computer readable program code configured to receive listing information from the customer at the Web site, the listing information including at least one of business market information, business category information and optional listing enhancement information relating to the placement and/or appearance of the listing in the business directory.

63. The computer program product of claim 62 wherein the listing information further includes basic business information including a business name, a business address, and a business telephone number.

64. The computer program product of claim 62 wherein the listing information includes business market information, the business market information including a region or market in which the customer wishes the business listing to appear.

65. The computer program product of claim 62 wherein the listing information includes business category information, the business category information including at least one business category under which the customer wishes to list the business in the business directory.

66. The computer program product of claim 65 wherein the business category information includes at least two categories under which the customer wishes to list the business in the business directory.

67. The computer program product of claim 65 further comprising:
computer readable program code configured to display at the Web site a list of available business categories; and
computer readable program code configured to receive from the customer at the Web site a selection of a business category from the list of available business categories.

68. The computer program product of claim 67 further comprising:
computer readable program code configured to display at the Web site a list of available business subcategories within the business category selected by the customer; and
computer readable program code configured to receive from the customer at the Web site a selection of a business subcategory from the list of available business subcategories.

69. The computer program product of claim 62 wherein the listing information includes optional listing enhancement information and the optional listing enhancement information includes graphical and/or textual indicia the customer wishes to appear on the listing in the business directory, the graphical and/or textual indicia including at least one of a customer Web site link, a customer email link, enhanced text, listing highlighting, and a link to a supplemental listing.

70. The computer program product of claim 69 wherein the graphical and/or textual indicia includes a link to an enhanced listing, the computer program product further including computer readable program code configured to receive supplemental information from the customer at the Web site that the customer wishes to be displayed when the link to the supplemental listing is accessed by a directory user.

71. The computer program product of claim 69 wherein the graphical and/or textual indicia includes enhanced text, the computer program product further including computer readable program code configured to receive enhanced text information from the customer at the Web site that the customer wishes to appear on the listing in the business directory.

72. The computer program product of claim 57 further comprising computer readable program code configured to receive billing information from the customer at the Web site.

73. The computer program product of claim 57 further comprising computer readable program code configured to generate a price quote for the business listing ordered by the customer and display the price quote to the customer at the Web site.

74. The computer program product of claim 73 wherein computer readable program code configured to generate the price quote includes computer readable program code configured to calculate the price quote based on features requested by the customer to be included in the business listing.

75. The computer program product of claim 57 further comprising:
computer readable program code configured to display a statement of terms and conditions to the customer at the Web site; and
computer readable program code configured to receive confirmation of acceptance of the terms and conditions from the customer at the Web site.

76. The computer program product of claim 57 further comprising computer readable program code configured to generate an order confirmation and display the order confirmation to the customer at the Web site.

77. The computer program product of claim 57 wherein the order serves to provide enhancements to an existing business listing in the business directory.

78. The computer program product of claim 57 wherein the business directory is an online business directory.

79. The computer program product of claim 57 further comprising computer readable program code configured to send the customer an email including information regarding the order for the listing in the business directory.

80. The computer program product of claim 57 wherein the business directory is a classified business directory, the computer program product further comprising:
computer readable program code configured to receive listing information from the customer at the Web site, the listing information including:
basic business information including a business name, a business address, and a business telephone number; and
at least one of business market information, business category information and optional listing enhancement information relating to the placement and/or appearance of the listing in the classified business directory;
computer readable program code configured to receive billing information from the customer at the Web site;
computer readable program code configured to generate a price quote for the business listing ordered by the customer and display the price quote to the customer at the Web site, the computer readable program code configured to generate the price quote including computer readable program code configured to calculate the price quote based on features requested by the customer to be included in the business listing; and
computer readable program code configured to generate an order confirmation and display the order confirmation to the customer at the Web site.

81. The computer program product of claim 80 wherein the listing information includes business market information, the business market information including a region or market in which the customer wishes the business listing to appear.

82. The computer program product of claim 80 wherein the listing information includes business category information, the business category information including at least one business category under which the customer wishes to list the business in the classified business directory.

83. The computer program product of claim 80 wherein the listing information includes optional listing enhancement information and the optional listing enhancement information includes graphical and/or textual indicia the customer wishes to appear on the listing in the classified business directory, the graphical and/or textual indicia including at least one of a customer Web site link, a customer email link, enhanced text, listing highlighting, and a link to a supplemental listing.

84. The computer program product of claim 80 wherein the classified business directory is an online classified business directory.
